(19) United States
(12) Patent Application Publication
(10) Pub. No.: US 2024/0140249 A1
(43) Pub. Date: May 2, 2024

(54) METHOD FOR AUTHORIZING A FIRST PARTICIPANT IN A COMMUNICATION NETWORK, PROCESSING DEVICE, MOTOR VEHICLE AND INFRASTRUCTURE DEVICE

(71) Applicant: AUDI AG, Ingolstadt (DE)

(72) Inventors: Marcel DIETZ, Ingolstadt (DE); Kevin OSTHEIMER, Ingolstadt (DE); Leonard DORLÖCHTER, Berlin (DE); Pavlo FOMENKO, Berlin (DE)

(73) Assignee: AUDI AG, Ingolstadt (DE)

(21) Appl. No.: 18/548,373

(22) PCT Filed: Mar. 10, 2022
(86) PCT No.: PCT/EP2022/056140

§ 371 Date: Aug. 30, 2023

(30) Foreign Application Priority Data
Mar. 15, 2021 (DE) 10 2021 106 261.6

(51) Int. Cl. B60L 53/66; B60L 53/65

(52) U.S. Cl. CPC B60L 53/66; B60L 53/65; B60L 2250/20

(57) ABSTRACT

A method for authorizing a first participant in a communication network, via which a plurality of participants communicate. A respective identification information is associated with each of the participants, the method includes: transmitting the identification information of the first participant to a second participant in the communication network, which is a processing device; checking, by the processing device, whether authorization data associated with the identification information is present in a data structure; and enabling a function of the second participant exclusively upon fulfillment of an authorization condition evaluating the authorization data, which condition can only be fulfilled if authorization data associated with the identification information are present.

### FIELD

The invention relates to a method for authorizing a first participant in a communication network, via which a plurality of participants communicate, wherein identification information is associated with each of the participants. Moreover, the invention relates to a processing device, a motor vehicle and an infrastructure device.

### BACKGROUND

It is useful if motor vehicles can handle interactions with infrastructural devices, in which payment transactions may also be important, in a largely automated manner This can be particularly important, for example, when charging a motor vehicle at a public charging device, since this process has to be carried out regularly when parking in a public space, for example, and should thus generate as little effort as possible for a user. Automation can also make it possible, for example, for a fully automated vehicle to approach a charging device by itself and carry out the charging process without user intervention or the like.

It is also advantageous to automate a corresponding process for other operations, for example for access to restricted areas or areas where a fee is charged, such as parking garages or certain inner-city areas. At the same time, however, it should be avoided that personal data of a vehicle owner, account data or the like are provided to a multitude of possibly untrustworthy devices.

One possible approach to automating at least the payment process and achieving a high degree of data economy in the process is to use a blockchain-based payment system, such as is known from DE 10 2017 212 904 A1. The advantage of such payment systems is that, with a high degree of data economy, transactions within the blockchain are secured by the data structure used, so that it can be ensured, for example, that a credit associated with a user can only be spent once.

However, on the one hand, there remains the disadvantage that it is a credit-based system, which means that users must transfer credit in advance to the blockchain, in particular to a so-called “wallet” associated with the user, and, for example, direct debiting from an external account is not possible. In addition, a blockchain can only secure transactions within the blockchain itself, so that, for example, an actual charging amount provided, compliance with predefined parameters, compliance with security standards, etc. can be disputed between transaction participants, for example when charging a vehicle.

The second problem can be avoided to a large extent if the individual participants are certified, for example, with regard to the accuracy of energy metering and other technical parameters. In order to be able to check such a certification automatically, digital certificates can be used, for example, which can be generated in particular with the aid of asymmetric cryptography methods.

However, if it is to be possible to revoke such certificates, for example if a technical defect or targeted misuse is detected, a central certificate management system is required. However, this is a “single point of failure”, which means that it must be highly available and highly redundant. This results in high operating costs. In addition, the use of a central certificate management also leads to potential problems if, for example, an operator unexpectedly discontinues its operation.

### SUMMARY

The object of the invention is therefore to provide an improved method for authorizing a participant in a communication network, which in particular avoids the disadvantages of central certificate management.

This object is achieved by a method of the previously mentioned type, which comprises the following steps:
transmitting the identification information of the first participant to a second participant in the communication network, which is or comprises a processing device,
checking whether authorization data associated with the identification information is present in a data structure by the processing device, wherein the data structure used is replicated on a plurality of processing devices, as participants communicating via the communication network, and comprises a plurality of data blocks which are ordered in a sequence and linked to each other in such a way that the content of a respective subsequent data block depends on the content of at least one preceding data block,
enabling a function of the second participant exclusively upon fulfillment of an authorization condition evaluating the authorization data, which condition can only be fulfilled if authorization data associated with the identification information are present.

The invention is based on the idea of no longer carrying out an authorization by means of a central device, but of keeping the required data locally in the respective processing device by replicating the required data structure in various processing devices, in particular in as many processing devices as possible in the communication network. By chaining the data blocks as described above, it is also possible to ensure that by the decentralized storage of the data structure, this structure is largely tamper-proof by using suitable approaches for adding further data blocks or replicating the data structure. Various corresponding implementation solutions are known in particular from the field of blockchains or cryptocurrencies, where credit balances or financial transactions are stored instead of authorization data.

Since a decentralized and, in particular, tamper-proof system is thus used to check an authorization, it is not necessary to use a trustworthy central certificate management system. Instead, the required data security and thus trust in the content of the data structure can be achieved by technical measures. This means that the system always remains robust, even if individual participants drop out, and the costs of central certificate management are eliminated.

The sequence of data blocks can generally be defined by a one-dimensional or multidimensional acyclic graph. In the simplest case, a one-dimensional arrangement is used so that a unique sequence of blocks is defined. In particular, a subsequent data block can depend on the immediately preceding data block in this sequence.

The dependency of the subsequent data block on the content of the at least one preceding data block can consist in particular in the fact that the subsequent data block comprises a hash value, in particular a cryptographic hash value, of the preceding data block or blocks or information dependent thereon. This prevents the retrieval of a change of a data block that does not lead to a change of the hash value and thus to an inconsistency with the subsequent data block, except by employing a very high computing effort. If an attacker wants to change a data block, he must also regenerate all subsequent data blocks.

If the addition of valid data blocks to the data structure is, for example, relatively computationally intensive, which is referred to as “proof of work” with regard to blockchains, or is restricted due to further requirements, in particular by a so-called “proof of stake”, and if the data structure with the highest number of blocks is identified and replicated by the processing devices as the only currently valid data structure, a very high level of tamper resistance can be achieved overall.

The further requirement may be selected, for example, so that a certain participant can only generate a certain number of blocks in a certain time interval. The frequency of generation of blocks by a particular participant may depend in particular on the economic interest of the particular participant in the reliability of the data structure. The economic interest can be determined, for example, on the basis of the data structure itself, for example by taking into account the economic values mapped therein, or on the basis of a transaction volume or the like. Such an approach is also referred to as a “proof of stake”.

In particular, the data structure may be a blockchain and/or a distributed transaction database (“distributed ledger”) that stores individual transactions. In the simplest case, one transaction can be stored per data block. However, in case of high transaction volumes, it may be advantageous to combine several transactions in one data block. In particular, earlier transactions are stored in early data blocks of the sequence and later transactions in later data blocks of the sequence. An approximate time of the transaction can thus already be estimated based on the data block in which it is stored. Preferably, however, the individual transactions are additionally timestamped.

Preferably, each transaction is signed by the respective participant using secret information, in particular a secret key of a key pair in an asymmetric encryption process. Transactions can also be triggered and optionally signed by means of so-called “smart contracts,” i.e. computer programs that are provided as part of the data structure, in particular as a data block. In this case, the triggering of a transaction by such a smart contract requires, in particular, proof that a participant possesses the secret information, such as the private key. This proof can be provided by signing a request to the smart contract, but a challenge-response method or similar can also be used.

In a simple example, the authorization data may comprise the respective identification information and a variable or flag indicating whether the participant with this identification information is authorized or not. Preferably, however, the authorization data additionally comprises information indicating which participant created and/or changed the authorization data, and/or a digital signature of that participant, and/or a timestamp.

In principle, all participants can be or comprise processing devices. However, there may also be participants without their own or permanently associated processing devices. For example, identification information can be associated with a user in order to identify and authorize the user even if several users use the same processing device or the same user uses different processing devices.

If the data structure is also replicated in the processing device of the first participant, the method according to the invention also allows two-sided authorization and thus two-sided function enabling of two participants. This can make it possible, for example, for a charging operation of a motor vehicle at a charging device to be enabled only if it has been determined on the vehicle side that the charging device is authorized and on the charging device side that the motor vehicle is authorized.

It is possible that all participants are always connected to the communication network. However, applications are also possible in which individual participants or all participants are temporarily disconnected from the communication network and, for example, after reconnection to the communication network, they initially update the internal data structure if necessary. This can be done, for example, if a valid data structure with a larger number of blocks is provided by another participant. The updated data structure can then be used to authorize other participants as required.

The authorization data can be created and/or changed in the data structure in that a processing device which is a participant or part of a participant adds an additional data block to the data structure, which block depends on at least one of the preceding data blocks of the data structure. This procedure is particularly useful if the authorization condition always evaluates only the most recent or the most recent valid authorization data. The conditions for the validity of a transaction or of authorization data stored in the data structure will be explained later.

In the simplest case, the block can be added by the participant triggering the creation and/or change of the authorization data. However, it is also possible and quite common in implementations of blockchains or distributed transaction databases to combine several transactions, in particular transactions from different participants, in one data block.

This can be realized, for example, by the participant initiating the respective transaction or the creation and/or change of the authorization data writing this transaction into a transaction pool that is replicated between the participants or at least between those participants that are required to generate blocks. There, optionally, a check of the validity of the transaction can be performed, checking, for example, whether the transaction is validly signed by the participant, whether the participant is authorized to perform this transaction, etc. After a successful check, or if such a check is not performed, multiple transactions may be combined into one data block that is appended to the data structure.

The authorization data may include the identification information of the participant who triggered the or a creation and/or change of the authorization data and/or a signature linked to the identification information, wherein the fulfillment of the authorization condition depends on the identification information and/or the signature. In particular, only certain participants may be authorized to create and/or change authorization data. The authorization condition can only be fulfilled or be fulfillable if the identification information and/or the signature is associated with such authorized participants.

The association of the signature with the identification information may be inferable from the data structure or may be verifiable based on the data structure and/or the identification information. For example, the signature can be created by a cryptographic signature method, of which various are known, using a private key. If the identification information corresponds to the public key of this key pair, the signature can be verified directly on the basis of the identification information. Since the public key is usually relatively long, it may be advantageous to use a shorter alias as the identification information instead, whereby the association of this alias with the private key may be stored in the data structure.

The authorization condition can only be fulfilled or can only be fulfilled if permission data associated with the identification information and/or the signature are present in the data structure, indicating permission of the participant creating and/or changing the authorization data. The permission data can in itself indicate such permission.

However, indirect permission is also possible. For example, the permission data can give a participant a higher-level permission that entitles him or her to create or change sub-permission data. In this case, the authorization condition can or may be met if sub-permission data for the participant creating and/or changing the authorization data indicates that the participant is permitted to do so, wherein the sub-permission data contains identification information and/or a signature of a participant who is authorized by permission data to create and/or change sub-permission data. A multi-level hierarchy of permissions is also possible.

The permission data can be created and/or changed in the data structure by adding an additional data block to the data structure by a processing device which is a participant or part of a participant, which block depends on at least one of the preceding data blocks of the data structure. As explained above for the authorization data, only the most recent valid permission data can be taken into account. As also explained above for the authorization data, a participant or its processing device can trigger the creation and/or change by a transaction that is appended to the data structure as a data block either by itself or together with other transactions.

The or a creation and/or change of the permission data can be performed in an automated manner by a program executed by a processing device of at least one participant, which program is stored in particular in the data structure. Storing programs in data structures consisting of concatenated data blocks, for example in blockchains, is known per se, wherein such programs are also referred to as “smart contracts”. The program code is typically stored in a machine-independent script language and can be stored in a relatively early data block in order to achieve a high level of tamper resistance. Optionally, the program code of the program can be uniform for each participant interacting with the data structure or blockchain. This enables a fixed framework of rules and creates trust among the participants.

The creation and/or change of the permission data may depend on reconciliation data provided by a plurality of participants to the processing device executing the program, in particular as part of the data structure. In other words, the program or smart contract is controlled by specific participants authorized for selection, thus completely eliminating the need for a central authority. The program that automatically creates and/or changes the authorization data is effectively the central authority and can therefore also be referred to as the “root contract”.

The collection of reconciling data can be triggered in a target manner, for example by calling this program by a participant, after which, for example, corresponding queries can be sent to the participants authorized to reconcile, after which they cast their vote and authenticate it, for example, by means of a signature.

Additionally and alternatively, however, it may also be advantageous to run the program automatically at certain times, for example each time a new data block is appended to the data structure or after a certain number of data blocks have been appended. Reconciliation data may be appended to the data structure by the authorized participants prior to this time, or may be stored in a transaction buffer so that the program can evaluate the votes automatically.

For example, permission data can only be created and/or changed if there is a minimum number of yes votes and fewer no votes than yes votes. It may also be possible to assign a different weight of votes to different participants, for example on the basis of their economic interest in robustness of the data structure. The voting rights of the participants can also be managed via the data structure. For example, voting rights data may be stored there for individual participants, indicating whether or not they are entitled to vote or how many votes they have.

The permission data, the authorization data, the voting right, etc. can be stored independently of each other in the data structure. However, it is also possible to combine several of these data in a common data record that describes, for example, the identification information of the respective participant and their rights. Instead of explicitly storing the individual rights, the individual participant can also be assigned a specific role, which in turn is associated with specific rights, for example via a data record in the data structure.

The permission to create and/or change authorization records can apply generally or can refer to specific groups of participants. If, for example, charging stations, motor vehicles and vehicle users participate in the procedure as participants, a vehicle manufacturer as a participant may, for example, only be authorized to create and/or change authorization data relating to motor vehicles and/or their users. An operator of charging devices, on the other hand, may only be authorized to create and/or change authorization data relating to these charging stations.

It may also be possible, for example, that only the participant who has created the authorization data of a certain other participant, or optionally a participant authorized by the latter, can change this authorization data. For example, this can prevent a vehicle manufacturer from changing the authorization data of another manufacturer's vehicle.

At least some of the data stored in the data structure is not readable or cannot be read in plain text by some of the participants, in particular by encrypting this data. Thus, in particular, different reading rights can be implemented for different participants.

For example, data can be encrypted by the public keys for all participants who should have access to this data, and the data cannot be stored in plain text. Thus, only those participants who know a respective associated private key have access to the stored data.

If it is ensured in the application that certain programs or program parts, such as smart contracts, are executed in a tamper-proof environment, the control of write or read rights can also be performed via the program or program part.

It is useful to check write permissions to the data structure also through a program, in particular a smart contract, which can, for example, check signatures of transactions that are to perform certain actions. This can be done, for example, when various transactions are combined into a data block, wherein transactions that are not signed or not validly signed can be discarded.

Independently of such a check, before changing the data structure, it may be useful to check the permission of the participant initiating the transaction or its signature also during evaluation, for example as part of the authorization condition, in order to further increase tamper resistance.

It may be useful to keep metadata for the respective identification information, which may, for example, relate to personal data of a user who is a participant or of a vehicle owner of a participating vehicle. For reasons of data protection and data economy, it is essential that no unauthorized access can be made to this data and that these can be deleted or at least made unreadable, at the request of the person, to whom these data are related.

If such metadata are stored in the data structure, they can be encrypted, for example, by the participant's public key, so that they can only be read if this participant's private key is known. Deleting the private key in this case results in the data being unreadable.

If actual deletion of the data is desired or required, for example, for data protection reasons, corresponding metadata can be stored separately from the data structure, whereby access to the metadata in this database is possible, for example, directly via the identification information or via a reference stored in the data structure, wherein this data is preferably encrypted, as explained above, in order to prevent unauthorized readout even if an attacker gains access to the database itself. Deleting the data record associated with the identification information in this database thus leads to a complete deletion of the metadata.

Participants may have read access to their own public keys and metadata. Participants who are authorized to create and/or change authorization data, in particular as explained above by authorization data stored in the data structure, may also be referred to as administrators. Administrators may have read rights on the public keys and metadata of participants whose authorization data has been created by them. They may additionally have read rights to the identification information and/or to the public key of participants who interact with participants authorized by them, such as participants to or from whom a transaction occurs. Optionally, it may also be possible to access metadata of these participants or at least parts of the metadata of these participants.

For example, motor vehicle manufacturers and operators of charging devices may possess read rights for the mutually interacting objects and users that constitute participants. However, motor vehicle manufacturers can preferably not read information about participants, i.e., in particular, motor vehicles or users, of other motor vehicle manufacturers, and charging device operators cannot read information about participants, in particular, charging devices or users, of other charging device operators.

Administrators can create identification information for a participant, in particular by generating a key pair for this participant. They can activate participants or the identification information associated therewith by creating or changing corresponding authorization data in such a way that the function is enabled. Different functions, services, etc. can also be enabled separately or together as a function. The respective administrator can trigger a status change of the respective participant by changing the authorization data, for example by setting a flag or variable to True or False.

Administrators can delete metadata of the participants they have authorized or created. Deleting the metadata and linking the metadata to the identification information or public key provides a high level of data protection, since there is no longer any directly personal information and transactions stored in the data structure can no longer be associated with a specific person.

A motor vehicle can be used as the first participant and an infrastructure device as the second participant, or vice versa. For example, an entrance to a certain area may be blocked by a barrier or similar and only enabled after authorization of the motor vehicle. In the opposite case, for example, a payment request from an infrastructure device, e.g. for access to a certain area or parking, can only be fulfilled after the infrastructure device has been authorized. Authorization of infrastructure devices can also be relevant, for example, if the control of the motor vehicle for an automated parking process or the like is to be transferred to the infrastructure device in order to ensure that the infrastructure device fulfills predefined requirements. The infrastructure device can in particular be a charging device for charging an energy storage of the motor vehicle.

Particularly advantageously, a motor vehicle can be used as the first participant and a charging device for charging an energy storage device of the motor vehicle can be used as the second participant, or vice versa, wherein the operation of the second participant is necessary for charging the energy storage device by the charging device. As explained above, authorization can in particular be provided on both sides, so that charging does not take place until both the charging device is authorized with respect to the motor vehicle and the motor vehicle is authorized with respect to the charging device. Thus, for operation of the charging device, a current output or, on the motor vehicle side, a charging control and/or a payment function can be enabled.

The data structure can additionally store transactions between participants, in particular with regard to enabled functions. A transaction relating to a charging process can, for example, include an identification of the transaction as relating to a charging process, the identification information of the motor vehicle and the charging device, and an amount of energy transferred. In addition, such a transaction may optionally include: a current state of charge of the energy storage device of the motor vehicle, a credit balance of the motor vehicle or of a user of the motor vehicle in a digital currency, quality criteria of the charging station, such as the accuracy of a power measurement, the maximum power that can be provided, or the like.

The transaction may also include an evaluation of the first participant by the second participant or vice versa, such as an evaluation of the charging process by the motor vehicle or the charging station. This information may be useful, for example, to provide vehicle manufacturers or charging station operators with information regarding possible improvements. For example, corresponding data can be evaluated by the vehicle manufacturer in order to supplement information on charging devices provided by the vehicle or to take into account corresponding information regarding route planning.

In addition to the method according to the invention, the invention relates to a processing device which is designed to participate in the method according to the invention as a participant or as part of a participant. The processing device may in particular comprise a communication device for communicating with the further participants, in particular for replicating the data structure, a memory device for storing the data structure and a computing unit for carrying out the method steps. The function that is enabled when the authorization condition is met can be a function of the processing device itself, for example performing a transaction on the data structure. However, the function may also be or comprise the control of a component external to the processing device, for example a charging control of a motor vehicle or a component of a charging device, an actuator of a barrier or other blocking devices, a traffic light control or similar devices.

The invention also relates to a motor vehicle comprising a processing device according to the invention, and to an infrastructure device, in particular a charging device, comprising a processing device according to the invention.

### BRIEF DESCRIPTION OF THE FIGURES

Further advantages and details of the invention will be apparent from the following exemplary embodiments and the associated drawings. In particular, schematically:

FIG. 1 shows exemplary embodiments of a motor vehicle according to the invention and of an infrastructure device according to the invention, namely a charging device, each comprising an embodiment of a processing device according to the invention and which are used in the context of an embodiment of the method according to the invention,

FIG. 2 shows an example of a data structure used in the method according to the invention, and

FIG. 3 shows a permission hierarchy that can be implemented by the method according to the invention.

### DETAILED DESCRIPTION

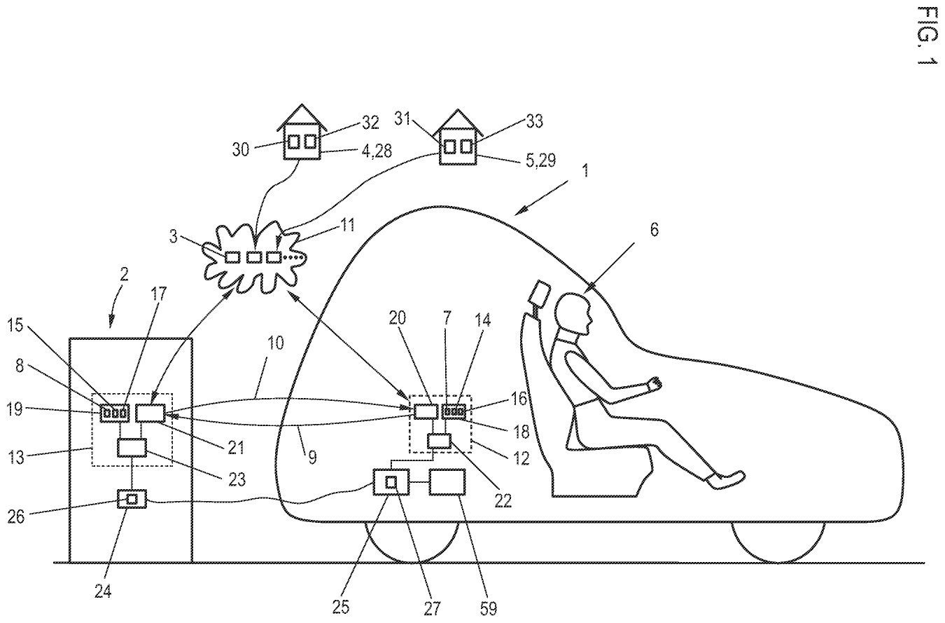

FIG. 1 shows an operating situation in which two participants 1, 2 in a communication network 11 are to be authorized to perform a certain function with respect to the respective other participant 1, 2. In the example shown, participant 1 is a motor vehicle and participant 2 is a charging station. Here, functions 26, 27 of a respective charging control 24, 25 are to be respectively enabled in order to enable charging of an energy storage device 59 of participant 1, i.e. the motor vehicle.

Here, the participants 1, 2 are each assigned identification information 7, 8, for example a public key of a key pair of an asymmetric encryption method, by means of which the respective participant 1, 2 can be identified. Before the functions 26, 27 are enabled and thus before the starting of the loading process, it is to be checked whether the participants 1, 2 are also authorized to carry out the charging process.

A corresponding authorization can in principle be carried out by further participants 3, 4, 5 in the communication network, in particular by participants 4, 5, who are authorized as administrators 28, 29 to grant and revoke such authorization. Here, for example, participant 4 can be a back-end system of a motor vehicle manufacturer and can grant and revoke authorizations for motor vehicles 1 manufactured by the manufacturer or their users 6. Participant 5, on the other hand, may be an operator of charging devices who can grant and revoke authorizations for charging devices operated by the same.

In order to allow such an authorization for enabling a respective function 26, 27, the respective identification information 7, 8 is first transmitted by the other of the participants 1, 2 to that participant 1, 2 which is to provide the corresponding function 26, 27. This is shown schematically in FIG. 1 by the arrows 9, 10, with this data exchange taking place via respective communication devices 20, 21 of processing devices 12, 13 of participants 1, 2. The information exchange can take place via the communication network 11 or also via a separate communication path, for example via a short-range wireless communication path or, in the case of a desired charging operation, also via the charging cable.

For the sake of completeness, it should be noted that for the procedure described below, it is not necessary for the individual participants 1 to 6 to be able to communicate via the communication network 11 at any given time, but it is sufficient if a data exchange with at least parts of the other participants 1 to 6 is possible at not too long intervals. For participants 6, for example users of motor vehicles, which do not have their own processing devices, communication takes place in particular via data processing devices which may or may not themselves also be participants with their own associated identification information.

A known approach to check an authorization in the case of known identification information 7, 8 is to query a central device as to whether an authorization exists for this identification information 7, 8. However, this requires the operation of a relatively complex central device and, moreover, to obtain an authorization, a robust communication link to this central device is required.

Therefore, in the described method, a different approach is used for authorizing participants 1, 2 with respect to the respective other participant 1, 2. Authorization is in each case carried out locally by the processing device 12, 13 of the respective participant. In addition to the aforementioned respective communication device 20, 21, the processing device has a storage device 18, 19 in which, in addition to the respective own identification information 7, 8, which in the example is a public key, a secret information, in the example a private key 14, 15, and a data structure 16, 17 are stored. The data structure 16, 17 may implement a decentralized transaction database. The processing steps are performed by a respective computing unit 22, 23.

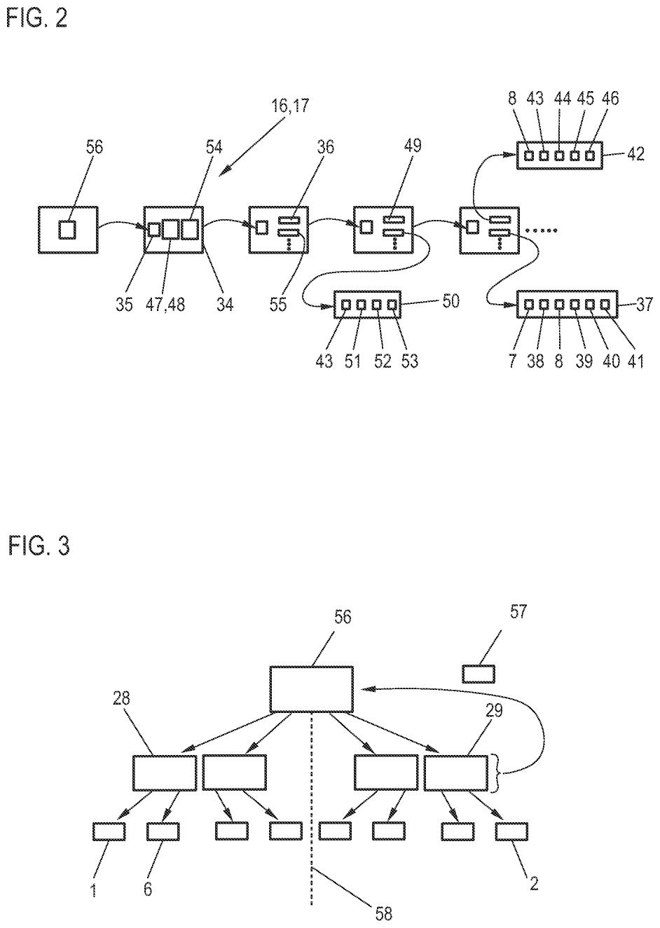

As shown schematically in FIG. 2, the respective data structure 16, 17 comprises several data blocks 34 which are linked to each other in such a way that the content of the respective subsequent data block 34 depends on the content of the preceding data block 34. This is implemented in the example by the fact that all data blocks 34 except the first data block store a cryptographic hash value 35 of the preceding data block. This results in the fact that in order to change one of the data blocks 34, it would also be necessary to change all subsequent data blocks in order to achieve consistency of the respective data structure 16, 17.

If the creation of new data blocks 34 is sufficiently computationally expensive and/or if other requirements are also present, such as a limit on the number of blocks that can be created by a particular participant in a particular time interval, a high level of manipulation security of the data structure is achieved in this way. Possible approaches have already been discussed in the general part and are well known in particular from the field of blockchains or cryptocurrencies.

At least parts of the data blocks 34 respectively store at least one transaction 36, i.e., a process that was triggered by one of the participants 1 to 6 or automatically by programs 48, 54, 56 controlling the data structure. For example, a charging data record 37 describing a preceding charging process of the motor vehicle 1 at the charging device 2 may be stored as transaction 36.

The charging data record 37 may comprise, for example, the identification information 7 of the motor vehicle, a signature 38 created using the private key 14 of the motor vehicle, the identification information 8 of the charging station, an amount of electricity 39 transferred during this charging process, additional information 40, for example an evaluation of the charging process, and a time stamp 41. If, for example, corresponding charging data records 37 are provided by both the motor vehicle and the charging device, which are then stored in one of the blocks 34 of the data structures 16, 17, a tamper-proof documentation of the charging process is thereby achieved.

By means of approaches known from the field of blockchains or crypto-currencies, it can also be achieved that the data structures 16, 17 stored by the individual participants or processing devices 12, 13 are generally identical, at least as far as older data blocks 34 are concerned. In particular, during a connection to the communication network 11 or at regular intervals by the respective participant 1 to 6 or a processing device 12, 13 used by the same, it can be queried whether a data structure with a higher number of blocks than the locally stored data structure 16, 17 is still present in the communication network 11. If this is the case, the validity of this data structure can be checked and, if the data structure with a larger block number is valid, this structure can be stored in order to replace the previously used data structure 16, 17.

In the method according to the invention, such a data structure 16, 17 is used to store authorization data 42, 49 for the respective participants 1 to 6. This is illustrated in the following example with respect to authorization of participant 2, but can also be applied accordingly to the authorization of other participants.

After the transmission of the identification information 8 of participant 2 to the processing device 12 of participant 1, the latter checks whether authorization data 42, 49 are present in the locally stored data structure 16, which are associated with this identification information 8, whether these are valid and whether they indicate an authorization of the participant 2. The verification of the authorization condition 47 can be carried out in particular by a program 48 which is stored as part of the data structure 16, 17. In this way, a high degree of manipulation security can be achieved for the program 48.

The authorization condition 47 can initially only take into account the most recent authorization data 42 relating to participant 2 or its identification information 8. The respective authorization data 42, 49 each comprise the identification information 8 associated therewith, an identification information 43 of the participant 1 to 6 who triggered the creation or the change of the authorization data 42, 49, a signature 44 of this participant, a status 45 of the authorization and a timestamp 46. The status 45 may, for example, be a flag indicating whether an authorization is present or not and may, for example, have the value 1 or 0 or “True” or “False”.

In a first step, it is checked whether the respective authorization data 42, 49 are valid. In particular, it can be checked whether the signature 44 is valid, which is possible by common cryptographic signature methods. In addition, as will be explained in more detail later, it is checked whether the participant 1 to 6 identified by the identification information 43 was permitted to create or change the authorization data 42, 49 associated with identification information 8.

If the most recent authorization data 42 is valid, the status information 45 is read out, indicating whether the participant 2 is authorized or not. If the status information 45 indicates authorization, the function 27 is enabled in the motor vehicle.

If, on the other hand, the most recent authorization data 42 is invalid, the check is repeated for the earlier authorization data 49 and the procedure is followed accordingly. If the earlier authorization data 49 is also invalid and there is also no further authorization data for the identification information 8 in the data structure 16, the authorization condition 47 is not fulfilled and the function 27 remains blocked, since the user 2 is not authorized for a charging process.

The check whether the user identified by the identification information 43 was permitted to create or change the authorization data 42, 49 can be checked, for example, by the program 54 which is also provided by the respective data structure 16, 17.

In principle, it would be possible to specify which users 1 to 6 are authorized to create or change authorization data. However, it is preferred if the authorization to create and change authorization data 42, 49 can be granted to or withdrawn from certain participants as required in order to designate them as administrators 28, 29 or to remove them from the pool of administrators 28, 29.

A corresponding approach is explained in more detail below with additional reference to FIG. 3, in which FIG. 3 schematically illustrates the authorization pyramid used. In the relatively simple example shown, motor vehicles or their users, i.e. participants 1 and 6 in the example, on the one hand, and charging devices, i.e. participant 2 in the example, on the other hand, are ultimately to be authorized to carry out charging processes. As indicated by the dashed line 58, a clear separation can be made so that, on the one hand, administrators 28 such as backend systems of motor vehicle manufacturers can serve as administrators, via which motor vehicles and users of motor vehicles can be authorized, and on the other hand backend systems of charging device operators can serve as administrators 29, which authorize the charging devices operated by them.

For example, different charging station operators can only authorize their own charging stations or withdraw their authorizations and manage additional information. Similarly, vehicle manufacturers can only authorize their own vehicles and users, withdraw their authorizations or manage their data.

A change in the permission of participants 4, 5 as administrators 28, 29 is preferably not performed directly by an individual participant 1-6, but by a program 56, which in particular can also be provided via the data structure 16, 17, and which triggers storage of authorization data 50, 55 in the data structure 16, 17 when corresponding voting data 57 from participants 1 to 6 with voting rights are available.

In the example shown in FIG. 3, it is assumed that all participants 4, 5 who are administrators 28, 29 are entitled to vote, whereby voting weights may depend in particular on the economic interest in the robustness of the data structure 16, 17, i.e., for example, on the number of participants 1 to 6 authorized by them, on sales generated by charging operations, or the like. In particular, the voting weights can thus be derived directly from the data structure itself. In other embodiments, however, it would also be possible for a voting right to be independent of administrator status.

The polling of the voting data 57 by the program 56 may be performed, for example, in that the program 56 is locally invoked by a participant, who then sends corresponding queries to other participants entitled to vote, who can express their consent, for example, by signed responses. If, for example, a sufficient number of yes votes and, in particular, a smaller number of no votes are obtained by the program 56, it can create new permission data 50, 55 as a transaction which is added to the data structure 16, 17 immediately or at a later time, as part of an additional data block 34. Since this leads to a larger block number of the data structure 16, 17, the correspondingly extended data structure 16, 17 is adopted by the further participants and thus the changes of the authorization are communicated to them.

As mentioned above, in the context of the authorization condition 47, it can also be checked, e.g. by the program 54, whether the participant 1 to 6 identified by the identification information 43 was permitted to create the respective evaluated authorization data 42, 49. For this purpose, the program 54 can check whether authorization data 50, 55 associated with this identification information 43 are present in the data structure 16, 17.

In the example shown in FIG. 2, the authorization data 50, 55 each comprise the identification information 43 with which they are associated and a status information 51 which indicates, for example by means of a 0 or 1 value or a “True” or “False” value, whether such a permission exists. Additionally information can be stored indicating for which of the participants 1 to 6 or for which type of participants 1-6 this authorization applies.

In order to be able to check the validity of the authorization data 50, 55, these also include an authorization field 52, which comprises, for example, signatures of those participants 1 to 6 who have voted for the current authorization status. A time stamp 53 is also stored.

Similarly, as explained above for the authorization data 42, 49, only the most current authorization data 50 associated with the identification information 43 are initially taken into account. If these are valid, the status 51 indicates whether the participant 1 to 6 identified by the identification information 43 was authorized to create or change the respective authorization data 45, 49.

If, on the other hand, the authorization data 50 is invalid, for example due to incorrect signatures, the system reverts to earlier authorization data 55 and repeats the corresponding procedure. If no valid permission data is found in the data structure 16, 17, it is assumed that the participant 1 to 6 identified by the identification information 43 was not permitted to create the authorization data 42, 49, which is then considered invalid.

In order to achieve high data protection standards, on the one hand at least parts of the data stored in the data structure 16, 17 may not be readable by all participants 1 to 6. In particular, corresponding data can each be encrypted with the public keys of those participants 1 to 6 who have read access to the corresponding data, whereby only these participants 1 to 6 can read the data, since the associated private key 14, 15 is known to them.

On the other hand, the individual participants 1 to 6 are preferably identified only by their identification information 7, 8 and further metadata, for example addresses, account details or the like, are managed by respective administrators 28, 29, for example back-end servers of vehicle manufacturers or charging device operators.

These can be connected to the communication network 11 as participants 4, 5 and implement, in addition to a respective processing device 30, 31, a database 32, 33 for corresponding metadata. This makes it possible, for example, to delete corresponding metadata, when requested by a participant 1 to 6 or when retention periods have expired. Corresponding deletions within the data structure 16, 17 would not be easily possible, since its design, as explained, is aimed at preventing changes in data blocks 34 added at an early stage.

1-13. (canceled)

14. A method for authorizing a first participant in a communication network, via which a plurality of participants communicate, wherein a respective identification information is associated with each of the participants, comprising:
transmitting the identification information of the first participant to a second participant in the communication network, which is or comprises a processing device,
checking, by the processing device, whether authorization data associated with the identification information is present in a data structure, wherein the data structure used is replicated on a plurality of processing device communicating as participants via the communication network, and which comprises a plurality of data blocks which are ordered in a sequence and are linked to one another in such a way that the content of a respective subsequent data block depends on the content of at least one preceding data block, enabling a function of the second participant exclusively upon fulfillment of an authorization condition evaluating the authorization data, which condition can only be fulfilled if authorization data associated with the identification information are present.

15. The method according to claim 14, wherein the authorization data are created or changed in the data structure by a processing device which is a participant or part of a participant, by adding an additional data block to the data structure which depends on at least one of the existing data blocks of the data structure.

16. The method according to claim 14, wherein the authorization data comprise the identification information of the participant which triggered the or a creation and/or change of the authorization data, and/or a signature linked to the identification information, wherein the fulfillment of the authorization condition depends on the identification information and/or the signature.

17. The method according to claim 16, wherein the authorization condition is fulfilled or can be fulfilled only if permission data associated with the identification information and/or the signature are present in the data structure, which permission data indicate a permission of the participant creating and/or changing the authorization data.

18. The method according to claim 17, wherein the permission data are created and/or changed in the data structure by a processing device which is a participant or part of a participant, by adding an additional data block to the data structure which depends on at least one of the existing data blocks of the data structure.

19. The method according to claim 17, wherein the creation and/or change of the authorization data is automated by a program executed by a processing device of at least one participant, which is stored in particular in the data structure.

20. The method according to claim 19, wherein the or a creation and/or change of the authorization data depends on voting data which are provided by a plurality of participants to the processing device executing the program, in particular as part of the data structure.

21. The method according to claim 14, wherein at least some of the data stored in the data structure cannot be read at all or cannot be read in plain text by some of the participants, in particular by encrypting this data.

22. The method according to claim 14, wherein a motor vehicle is used as the first participant and an infrastructure device is used as the second participant, or vice versa.

23. The method according to claim 14, wherein a motor vehicle is used as the first participant and a charging device for charging an energy storage device of the motor vehicle is used as the second participant, or vice versa, wherein the function of the second participant is necessary for the charging of the energy storage device by the charging device.

24. A processing device, wherein the processing device is designed to participate in the method according to claim 14 as a participant or as part of a participant.

25. A motor vehicle, wherein the motor vehicle comprises a processing device according to claim 24.

26. An infrastructure device, in particular a charging device, wherein the infrastructure device comprises a processing device according to claim 24.

27. The method according to claim 15, wherein the authorization data comprise the identification information of the participant which triggered the or a creation and/or change of the authorization data, and/or a signature linked to the identification information, wherein the fulfillment of the authorization condition depends on the identification information and/or the signature.

28. The method according to claim 18, wherein the creation and/or change of the authorization data is automated by a program executed by a processing device of at least one participant, which is stored in particular in the data structure.

29. The method according to claim 15, wherein at least some of the data stored in the data structure cannot be read at all or cannot be read in plain text by some of the participants, in particular by encrypting this data.

30. The method according to claim 16, wherein at least some of the data stored in the data structure cannot be read at all or cannot be read in plain text by some of the participants, in particular by encrypting this data.

31. The method according to claim 17, wherein at least some of the data stored in the data structure cannot be read at all or cannot be read in plain text by some of the participants, in particular by encrypting this data.

32. The method according to claim 18, wherein at least some of the data stored in the data structure cannot be read at all or cannot be read in plain text by some of the participants, in particular by encrypting this data.

33. The method according to claim 19, wherein at least some of the data stored in the data structure cannot be read at all or cannot be read in plain text by some of the participants, in particular by encrypting this data.
